(19) United States
(12) Patent Application Publication
(10) Pub. No.: US 2022/0220943 A1
(43) Pub. Date: Jul. 14, 2022

(54) TOWER SEGMENT AND METHOD FOR CONSTRUCTING A TOWER

(71) Applicant: Wobben Properties GmbH, Aurich (DE)

(72) Inventors: Dieter OHMS, Magdeburg (DE); Markus LONGERU, Stade (DE); Bernd TELLENSKY, Görzig (DE)

(21) Appl. No.: 17/603,861

(22) PCT Filed: Apr. 8, 2020
(86) PCT No.: PCT/EP2020/060083

§ 371 Date: Oct. 14, 2021

(30) Foreign Application Priority Data
Apr. 15, 2019 (DE) 10 2019 109 904.8

(51) Int. Cl. F03D 13/20; F03D 13/10; E04H 12/08; E02D 27/42

(52) U.S. Cl. CPC F03D 13/20; E02D 27/425; E04H 12/085; F03D 13/10

(57) ABSTRACT

A tower segment, in particular for a tower of a wind power installation, to a tower, in particular a tower of a wind power installation, to a wind power installation and to a method for constructing a tower. In particular, the invention relates to a tower segment, in particular for a tower of a wind power installation, for attaching to a support structure, in particular to a foundation, comprising a tower base element having an upper end and a lower end, and a threaded opening arranged at the lower end, a flange, which is arranged at the lower end, having a first flange opening and a second flange opening, wherein the tower base element and the flange are connected by a fastening element arranged in the threaded opening and the first flange opening, and wherein the second flange opening is formed in such a way that a connecting element of the support structure can extend through the second flange opening.

### BACKGROUND

### Technical Field

The disclosure relates to a tower segment, in particular for a tower of a wind power installation, to a tower, in particular a tower of a wind power installation, to a wind power installation and to a method for constructing a tower.

### Description of the Related Art

Wind power installations are known in principle. Modern wind power installations generally relate to so-called horizontal-axis wind power installations in which the rotor axis is arranged substantially horizontally and the rotor blades sweep a substantially perpendicular rotor area. In addition to a rotor arranged on a nacelle, wind power installations generally comprise a tower on which the nacelle with the rotor is arranged so as to be rotatable about a substantially vertically oriented axis. The rotor generally comprises three rotor blades of equal length.

Towers are generally slender structures with a large height which have a comparatively small extent particularly orthogonally to this height. Towers are frequently produced from concrete and/or from steel. The range of tower designs extends from lattice constructions via steel tubular towers with or without cable bracing to concrete structures.

Steel tubular towers with large dimensions are generally produced from a plurality of components, in particular tower segments. Such a tower is also referred to as a segmented tower. Segmented towers can be segmented along their longitudinal extent. Such segments frequently have annular geometries. The towers can, moreover, be segmented in the horizontal direction such that the tower at one height consists of a plurality of segments arranged next to one another. Towers can have cylindrical and/or conical portions, in particular along their longitudinal extent, with towers often comprising cylindrical and conical portions.

Towers of wind power installations, in particular of modern horizontal-axis wind power installations, contribute to a considerable extent to the overall costs of the production of a wind power installation. Particularly the ever larger rotor diameters and powers of wind power installations lead to the fact that the towers are also becoming larger and are exposed to higher loads. The towers are becoming larger not only in terms of their height but also with regard to their diameter.

Moreover, the assembly of segmented towers at a set-location of the wind power installation is complicated. In particular, the horizontally adjacent segments require a large amount of time. Moreover, in the case of the logistics of the towers or the tower segments it should be borne in mind that a defined diameter or a defined height of the components is not exceeded since, for example, on bridges there is a drive-through restriction. In Germany, for example, there is such a drive-through restriction of, as a rule, 4.35 m. Moreover, distortions can regularly be found in towers which are segmented in the horizontal direction, making the assembly of the tower more difficult.

In the prior art, there are various approaches for reducing the costs and for increasing the quality of wind power installation towers. For example, DE 10 2011 077 428 A1 describes a wind power installation tower having a plurality of tower segments, wherein the tower segments abut at horizontal and vertical flanges and are fastened to one another here. DE 10 2004 017 006 A1 and DE 10 2010 039 316 A1 each describe solutions for fastening a tower to a foundation. The existing systems and methods for constructing and for manufacturing wind power installation towers offer various advantages, but further improvements are desirable.

The German Patent and Trademark Office has searched the following prior art in the priority application relating to the present application: DE 10 2013 109 765 A1, DE 10 2015 014 070 A1, EP 2 636 899 A1.

### BRIEF SUMMARY

Provided is a tower segment, in particular for a tower of a wind power installation, a tower, in particular a tower of a wind power installation, a wind power installation and a method for constructing a tower which may alleviate or eliminate one or more of the stated disadvantages. In particular, provided are techniques which allows simplified logistics of a tower.

According to a first aspect, provided is a tower segment, in particular for a tower of a wind power installation, for attaching to a support structure, in particular to a foundation, comprising a tower base element having an upper end and a lower end, and a threaded opening arranged at the lower end, a flange, which is arranged at the lower end, having a first flange opening and a second flange opening, wherein the tower base element and the flange are connected by a fastening element arranged in the threaded opening and the first flange opening, and wherein the second flange opening is formed in such a way that a connecting element of the support structure can extend through the second flange opening.

The tower base element preferably extends with a longitudinal extent from the upper end to the lower end. In the operating state, the lower end faces the support structure, in particular a foundation. In the operating state, the upper end preferably faces away from the support structure and, for example, faces a nacelle. Orthogonally to the longitudinal extent and in operation in the horizontal direction, the tower base element preferably extends in a radial direction. The tower base element can be tubular in form, for example. In particular, the tower base element can have a terminal side at the upper and at the lower end and an outer and an inner circumferential surface along the longitudinal extent. Between the outer and inner circumferential surface, that is to say in particular in the radial direction, the tower base element has a thickness. The thickness can also correspond to a material thickness.

The tower base element preferably comprises steel or consists of steel. Moreover, the tower base element can also comprise or consist of other materials. The tower base element can take the form, for example, of a sheet metal section or of a forged part.

The threaded opening is arranged at the lower end of the tower base element. The threaded opening can be, for example, a blind hole which has a circular cross section. Moreover, it is preferred that the threaded opening has a thread. Preferably, the threaded opening has an opening longitudinal axis which furthermore is preferably oriented parallel to the longitudinal extent between the upper end and the lower end of the tower base element.

The flange is arranged at the lower end of the tower base element. The flange has a first flange opening and a second flange opening. The fastening element, by which the tower base element and the flange are connected to one another, is arranged in the first flange opening of the flange and the threaded opening of the tower base element. The first flange opening and the threaded opening preferably each have a longitudinal axis, with these longitudinal axes furthermore preferably being oriented coaxially. The first flange opening preferably takes the form of a through-opening. The flange can, moreover, be plate-shaped in form. The flange preferably comprises steel or consists of steel. Furthermore, the flange can also comprise or consist of other materials.

The second flange opening of the flange is furthermore formed in such a way that the connecting element of the support structure can extend through the second flange opening. The support structure can be a foundation, for example. The connecting element can be, for example, a foundation cage bolt which preferably projects vertically out of the support structure. This connecting element extends through the second flange opening. On the side of the flange that faces away from the support structure, the connecting element is preferably connected to a further connecting element such that a fixed connection is formed between the flange and the support structure. For example, the connecting element can take the form of a foundation cage bolt and the further connecting element can take the form of a nut.

A fixed connection of the flange to the support structure is formed by guiding the foundation cage bolt through the second flange opening and securing the foundation cage bolt to a nut. Fastening the flange to the tower base element by means of the fastening element in turn achieves a fixed connection of the tower base element to the support structure. In particular, a force flow from the tower base element via the flange into the support structure can occur hereby.

The tower base element of a tower is as a rule the element, in particular the segment, of the tower, which has the largest diameter. Particularly in the case of the tower base element, the maximum drive-through height of 4.35 m (meters) and/or of 5 m of bridges, but also of critical regions, should thus be taken into account in the manufacture. In general, it is often necessary not to exceed a certain maximum diameter. The welded-on flanges on towers, in particular on tower base elements, that are known in the prior art result in an increase in the maximum diameter of the tower base element. However, it is not the tower base element and/or a tower wall that determines this larger diameter but the outwardly projecting flange. Consequently, the maximum diameter of a tower base element and/or of a tower wall does not account for the maximum possible diameter, since the flange projects from the tower base element and/or the tower wall and thus determines the diameter of the component. Arranging the flange on the construction site is generally not an option, since it is not possible on the construction site to achieve the required welding quality or the effort involved is disproportionately high.

The disclosure is based on the finding that, by means of a flange screwed onto the tower base element, the maximum utilization of a predetermined diameter is made possible by the tower base element. The tower base element with screwed-on flange can thus have a larger diameter than comparable tower base elements having a welded-on flange. It follows therefrom that the tower base element does not have to be segmented in many cases. Moreover, such a tower base element improves the frequency position, the strength and/or the stability of the tower. In addition, the tower base wall can be configured to be thinner, since the diameter becomes larger overall and thus a better material utilization can be achieved.

Preferably, the tower base element comprises a large number of threaded openings which are arranged along an annular extent of the tower base element. Analogously to this, the flange preferably has a large number of first flange openings along an, in particular annular, extent such that there is preferably provided for each of the large number of threaded openings a respective first flange opening on the flange. The threaded openings and/or the first flange openings can each take the form of a circle of holes, for example.

Moreover, it is preferable that the flange has a large number of second flange openings through which a large number of connecting elements of the support structure can be guided. In the horizontal direction and orthogonally to the longitudinal extent between the upper end and the lower end, the tower base element and/or the flange have or has a radial direction. The radial direction is horizontally oriented in particular between the tower base element and/or the flange and a centerpoint of the tower base element and/or of the flange. In the radial direction, the first flange opening and the second flange opening and/or the threaded opening can lie on a radial line. Moreover, it can be preferable that these openings are arranged so as to be offset from one another in the radial direction.

According to a preferred embodiment variant of the tower segment, there is provision that the threaded opening is arranged terminally at the lower end of the tower base element, and/or the first flange opening on the flange is arranged in such a way that it terminally adjoins the lower end.

The tower base element preferably has a terminal side at the lower end. It is at this terminal side that the threaded opening can be arranged. Preferably, the terminal side is a planar surface whose surface orthogonal is oriented parallel to the longitudinal extent of the tower base element between the upper end and the lower end. In particular, it is preferable that in operation the terminal side forms a substantially horizontal surface. Alternatively, the threaded opening can also be arranged circumferentially on the tower base element.

Furthermore, the first flange opening can terminally adjoin the lower end. Alternatively, the first flange opening can also circumferentially adjoin the lower end of the tower base element. The first flange opening terminally adjoining the tower base element makes it possible, in conjunction with the terminally arranged threaded opening at the lower end of the tower base element, to achieve a secure connection between the tower base element and the flange by means of the fastening element. The fastening element can be, for example, a screw, with the latter preferably having a longitudinal axis, with the longitudinal axis being coaxial to the longitudinal axes of the threaded opening and of the first flange opening, with it being the case that these longitudinal axes are preferably oriented vertically and/or coaxially in operation.

According to a further preferred embodiment variant of the tower segment, there is provision that the tower base element and/or the flange have or has an annular cross section.

What is to be understood here by cross section is in particular the section surface whose surface orthogonal in operation is oriented substantially vertically and/or parallel to the longitudinal extent of the tower base element and/or of the flange. The annular cross section of the tower base element and/or of the flange results in the fact that they have an outer circumferential surface and an inner circumferential surface. Furthermore, an annular cross section is also to be understood to mean polygonal and/or oval cross sections.

Moreover, the tower base element and/or the flange can also have a partly annular cross section. A partly annular cross section is distinguished in particular by the fact that it has an arc extent of less than 360°. For example, a partly annular cross section can have an arc extent of 180°, with the result that two of these partly annular tower base elements and/or flanges arranged on one another result in a complete ring having an arc extent of 360°.

In a further development of the tower segment, there is provision that the flange has a third flange opening, and the first flange opening is arranged in the radial direction between the second flange opening and the third flange opening, with the result that preferably the second flange opening has in the radial direction a smaller spacing from a centerpoint of the tower segment than the third flange opening in the radial direction from this centerpoint, and preferably the third flange opening is arranged in such a way that a connecting element of the support structure can extend through the third flange opening.

By means of the third flange opening, a more secure connection can be achieved between the flange and the support structure. Moreover, the number of the possible connecting elements between the flange and the support structure is increased, since the spacing between second flange openings cannot be arbitrarily reduced.

In particular, it is preferable that the second flange opening faces an outer circumferential surface of the tower base element, and the third flange opening faces an inner circumferential surface of the tower base element. The centerpoint is to be understood in particular as meaning a geometrical centroid. In the case of partly annular cross sections of the tower base element and/or of the flange, the centerpoint is preferably to be understood as meaning the point which corresponds to the geometrical centroid of the completely assembled annular geometry.

In a further preferred development of the tower segment, there is provision that the flange has in the radial direction a larger extent than the lower end of the tower base element. The flange extends here in particular in the radial direction inwardly and outwardly away from the tower base element. As a result, the arrangement of second and/or third flange openings is simplified.

In a preferred development, the tower segment is developed to the effect that it comprises a load element, which is arranged on the flange, having a first load element opening and/or a second load element opening, wherein the fastening element is arranged partially within the first load element opening, and/or the second load element opening has a common through-passage axis with the second flange opening, and wherein preferably the load element has a third load element opening which has a common through-passage axis with the third flange opening.

The load element can be, for example, a load ring or a load distribution ring. The load element is arranged in particular on the side of the flange that faces away from the tower base element. The load element preferably has the first load element opening, with the latter further preferably having a common longitudinal axis with the first flange opening and the threaded opening. Preferably, the diameter and/or the extent in the horizontal direction, in particular orthogonally to the longitudinal extent of the tower base element, of the first load element opening is larger than the diameter and/or the extent of the first flange opening.

The first load element opening can be used, for example, for the purpose of arranging therein a screw head of a screw which extends through the first flange opening and is screwed within the threaded opening. The screw head can then have its bearing surface bearing against the flange, in particular bearing on the side of the flange that faces away from the tower base element. The thickness of the load element and/or the thickness of the screw head are/is preferably provided in such a way that the screw head is able to be arranged completely in the first load element opening.

A support structure, in particular a foundation, is as a rule not able to be formed completely horizontally. That is to say that the support structure, in particular the foundation, has a slight inclination. In the case of wind power installations with their considerable height, such an inclination results in a non-negligible oblique position.

The load element can be used to compensate for this inclination which deviates from the horizontal. For this purpose, the load element is arranged on the support structure, in particular the foundation, and positioned on the support structure using suitable compensation means, in particular mortar, in such a way that the side of the load element that faces away from the support structure and on which the flange is arranged has a substantially horizontal extent without substantial inclination.

After the load element with the compensation means, in particular the mortar, has been arranged on the support structure, the flange with the tower base element fastened thereto can be arranged on the load element. For this purpose, the load element has the second load element opening and/or the third load element opening through which the connecting elements of the support structure can extend.

It can be preferable that the load element does not have a first load element opening. For this purpose, it is possible, for example, for the support structure, in particular the foundation, to have a recess in which, for example, the screw head is able to be arranged.

Moreover, it is preferable that the load element is annular or partly annular in form, and/or the flange and the load element are formed integrally. Preferably, the load element has the same geometry as the flange. Moreover, the load element and/or the flange can have the same cross section as the tower base element.

In a further preferred embodiment variant of the tower segment, there is provision that the fastening element takes the form of a screw, and/or the fastening element has a threaded bolt and a nut, wherein the threaded bolt is screwed into the threaded opening and extends through the first flange opening and is screwed to the nut on the side of the flange that faces away from the tower base element, and/or the fastening element has a threaded bolt, a cross bolt, with a cross bolt opening, and a nut, wherein the threaded bolt is screwed into the threaded opening and extends through the first flange opening and, on the side of the flange that faces away from the tower base element, extends through the cross bolt opening and is screwed to the nut.

The cross bolt preferably has at least one extent which is larger than that of the first flange opening such that the cross bolt can be supported on the side of the flange that faces away from the tower base element. The above-stated nut can also take the form of an expansion sleeve. An expansion sleeve has the further advantage that a further prestressing of the connection is made possible.

According to a further development of the tower segment, there is provision that a dimension of the first flange opening in the radial direction is smaller than a thickness of the tower base element in the radial direction. In this preferred embodiment variant, the tower base element stands completely on the flange and has no portions which are arranged completely over the flange opening. As a result, the stability of the arrangement is improved.

According to a further preferred embodiment variant, there is provision that the tower base element has at the lower end a thickened portion whose radial extent is larger than the radial extent of a tower wall, and/or the upper end of the tower base element is designed for arranging a tower wall.

In this preferred embodiment variant, the longitudinal cross section of the tower base element whose surface orthogonal is oriented substantially parallel to a circumferential direction of the tower base element preferably has a bottle-shaped geometry. In particular, this is distinguished by the fact that the lower end has a larger radial extent than a radial extent of the tower wall. Moreover, it can be preferable that the tower base element has at the lower end a larger radial extent than at the upper end. The thickened portion is designed in particular for the threaded opening to be arranged therein. As a result of the thickening in this region, the strength can be improved in spite of the threaded opening, in particular a large number of threaded openings.

The upper end of the tower base element is formed in particular in such a way that a tower wall can be arranged thereon. For example, the tower wall can be arranged by means of a welding method. The tower segment can additionally comprise a tower wall with an annular cross section, wherein the tower wall is arranged at the upper end of the tower base element and is preferably welded to the tower base element. The tower wall preferably has a smaller radial extent than the tower base element, in particular than the thickened portion of the tower base element.

Moreover, it is preferable that the connection of the tower base element to the flange and preferably of the flange to the load element is designed to be free of a welded connection. Moreover, there can be provision that the flange takes the form of a segmented flange, and preferably has at least two horizontally adjacent flange segments.

According to a further aspect, the object stated at the outset is achieved by means of a tower, in particular a tower of a wind power installation, comprising at least one tower segment according to at least one of the above-described embodiment variants, a support structure, in particular a foundation, having at least one first connecting element which is preferably fixedly connected to the support structure, wherein the first connecting element extends through the second flange opening, and preferably through the second load element opening, and is preferably connected to a corresponding second connecting element on the side of the flange that faces away from the support structure in such a way that a fixed connection is formed between the flange and the support structure.

The second connecting element can be, for example, a nut or an expansion sleeve. Moreover, the first connecting element can also take the form of a screw, wherein the screw is preferably guided first of all through the second flange opening, is preferably likewise guided through the second load element opening, and is screwed in the support structure. For this purpose, the support structure preferably has threaded openings.

According to a preferred embodiment variant of the tower, there is provision that the support structure has at least one further first connecting element which is preferably fixedly connected to the support structure, wherein the further first connecting element extends through the third flange opening, and preferably through the third load element opening, and is connected to a further corresponding second connecting element on the side of the flange that faces away from the support structure in such a way that a fixed connection is formed between the flange and the support structure.

According to a further aspect, the object stated at the outset is achieved by means of a wind power installation, comprising a tower segment according to at least one of the above-described embodiment variants, and/or a tower according to at least one of the above-described embodiment variants.

According to a further aspect, the object stated at the outset is achieved by means of a method for constructing a tower, in particular a tower of a wind power installation, comprising the steps of providing a support structure, in particular a foundation, having a first connecting element, arranging a flange having a first flange opening and a second flange opening at a lower end, in particular a terminal lower end, of a tower base element which has a threaded opening, fastening the flange to the lower end, in particular the terminal lower end, of the tower base element by arranging a fastening element in the threaded opening and the first flange opening, arranging the flange on the support structure such that the first connecting element extends through the second flange opening.

In a preferred embodiment variant of the method, there is provision that it comprises the following steps: arranging a load element between the support structure and the flange having a first load element opening and/or a second load element opening, arranging the fastening element at least partially within the first load element opening and/or guiding the first connecting element through the second load element opening, and preferably guiding a further first connecting element of the support structure through a third load element opening.

The method and its possible developments have features or method steps which make them suitable in particular to be used for a tower segment and its developments. For further advantages, embodiment variants and embodiment details of these further aspects and their possible developments, reference is also made to the above description relating to the corresponding features and developments of the tower segment.

### BRIEF DESCRIPTION OF THE SEVERAL VIEWS OF THE DRAWINGS

Preferred exemplary embodiments will be explained by way of example on the basis of the appended figures, in which:

FIG. 1 shows a schematic illustration of a wind power installation;

FIG. 2 shows a schematic, two-dimensional view of a tower segment;

FIG. 3 shows a schematic, two-dimensional sectional view of a tower segment;

FIG. 4 shows a schematic, two-dimensional view of a tower segment known in the prior art.

### DETAILED DESCRIPTION

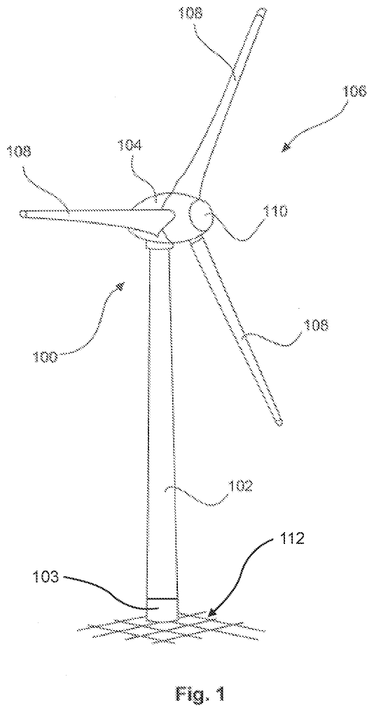

FIG. 1 shows a schematic illustration of a wind power installation 100. FIG. 1 shows a wind power installation 100 having a tower 102 and a nacelle 104. On the nacelle 104 there is arranged a rotor 106 with three rotor blades 108 and a spinner 110. In operation, the rotor 106 is set into a rotational movement by the wind and thereby drives a generator in the nacelle 104.

The tower 102 has a tower segment 103 at an end thereof that faces away from the nacelle 104. The tower segment 103 has a tower base element with an upper end, which faces the nacelle 104, and a lower end which faces the foundation 112. At the lower end of the tower base element, the latter has a large number of threaded openings. Between the tower base element and the foundation 112 there is further arranged a flange having a first flange opening and a second flange opening.

The tower base element is connected to the flange by means of a fastening element. For this purpose, the tower base element has the threaded opening and the flange has the first flange opening. The foundation 112 has, furthermore, connecting elements which extend through the second flange openings. The connecting elements are designed in such a way that a fixed connection is able to be produced between the flange and the foundation 112. A force acting on the tower 102 or a moment acting on the tower 102 is thus channeled via the tower base element into the flange and from the latter into the foundation 112.

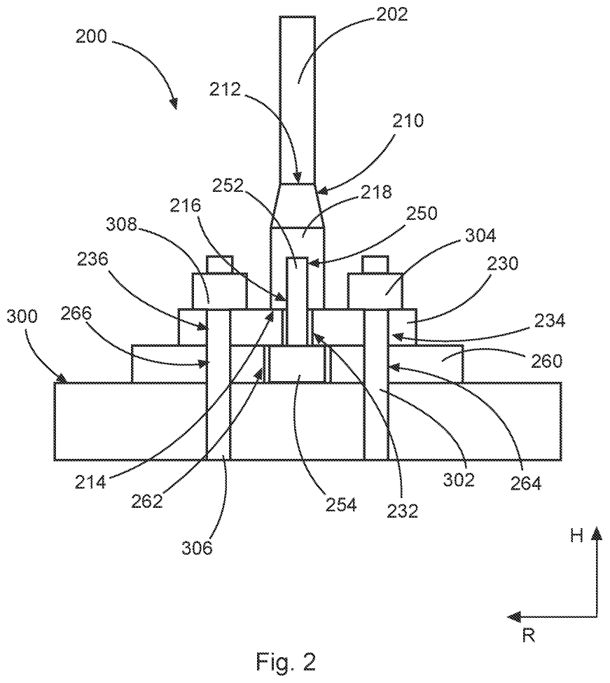

FIG. 2 shows a schematic, two-dimensional view of a tower segment. The tower segment 200 has a tower base element 210, a flange 230 and a load element 260. The tower segment 200 is arranged on a foundation 300. At an upper end 212 of the tower base element 210 there is arranged a tower wall 202.

The tower base element 210 extends in its longitudinal direction from the upper end 212 to the lower end 214. The longitudinal extent of the tower base element 210 is substantially parallel to a height H of the tower segment 200. The height H is substantially vertically oriented in the operating state shown.

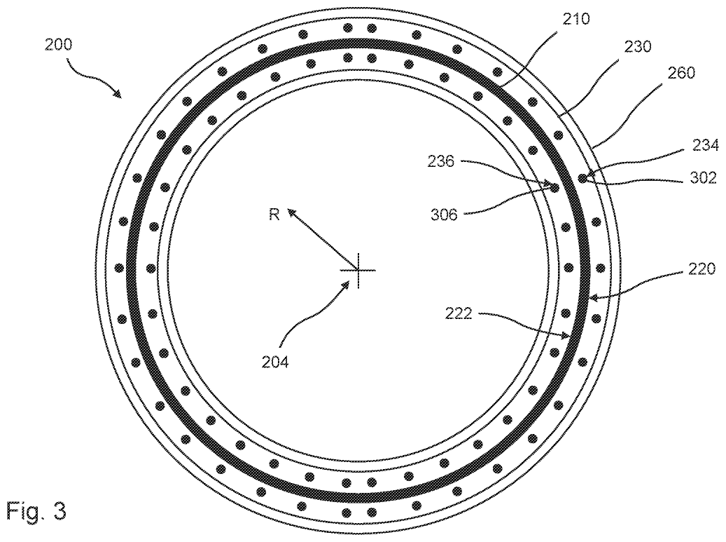

The tower segment 200 is preferably annular in form and has a centerpoint. The centerpoint is not shown here and is for example on the left in the image. The arrangement of the centerpoint can be gathered in particular from FIG. 3 described below. The extent from the centerpoint to the tower segment 200 is oriented in the radial direction R. The tower base element 210 has a threaded opening 216. The threaded opening 216 is arranged terminally at the lower end 214 of the tower base element 210. The tower base element 210 is designed to be terminally planar in form. The tower base element 210 further has, in a region adjoining the lower end 214, a thickened portion 218 and tapers from the thickened portion 218 to the upper end 212.

The flange 230 is terminally arranged at the lower end 214 of the tower base element 210. The flange 230 has the first flange opening 232, the second flange opening 234 and the third flange opening 236. The first flange opening is arranged substantially centrally with respect to the radial extent in the radial direction R of the flange 230. The second flange opening 234 has in the radial direction R a larger spacing from the centerpoint of the flange 230 than the third flange opening 236. In the state shown, the third flange opening 236 faces an inner circumferential surface of the tower base element 210. The second flange opening 234 faces an outer circumferential surface of the tower base element 210.

Between the flange 230 and the foundation 300 there is arranged the load element 260. In the vertical direction, the load element 260 is arranged between the flange 230 and the foundation 300. The load element 260 has a first load element opening 262, a second load element opening 264 and a third load element opening 266.

The first load element opening 262 is arranged substantially centrally with respect to the radial extent in the radial direction R of the load element 260. In particular, the first load element opening 262 is arranged in such a way that it has a common longitudinal axis with the first flange opening 232 and the threaded opening 216. The second load element opening 264 and the third load element opening 266 are spaced apart from the first load element opening 262 in the radial direction R. In particular, the second load element opening 264 is spaced further apart from the above-defined centerpoint than the third load element opening 266.

The flange 230 is connected to the tower base element 210 by means of a fastening element taking the form of a screw 250. The screw 250 has a screw shank 252 and a screw head 254. The screw shank 252 extends through the first flange opening 232 and is screwed into the threaded opening 216. The screw head is arranged so as to bear against a horizontal surface of the flange 230 that faces away from the tower base element 210. A force fit can thus be produced between the tower base element 210 and the flange 230.

The foundation 300 has a first connecting element 302 and a third connecting element 306. The first connecting element 302 and the third connecting element 306 projects substantially vertically out of the foundation 300 in the upward direction. The first connecting element 302 extends through the second load element opening 264 and through the second flange opening 234. The first connecting element 302 exits the second flange opening 234 vertically. At this point, the first connecting element 302 is coupled to a second connecting element 304 taking the form of a nut. The nut is screwed onto a thread at the distal end of the first connecting element 302. As a result, a fixed connection of the flange 230 via the load element 260 to the foundation 300 is made possible.

Analogously to this, the third connecting element 306 extends through the third load element opening 266 and through the third flange opening 236 and is secured to a fourth connecting element 308, in the present case likewise a nut. The force fit occurs in that forces of the tower base element 210 can be transmitted to the flange 230, in particular by means of the screw 250. A force is in turn transmitted from the flange via the load element into the foundation 300, wherein this connection between the flange 230, load element 260 and foundation 300 occurs by means of the connecting elements 302, 304, 306, 308.

FIG. 3 shows a schematic, two-dimensional sectional view of the tower segment 200. The tower segment 200 has a centerpoint 204. The tower base element 210, the flange 230 and the load ring 260 have a substantially annular cross section. The tower base element 210, the flange 230 and the load ring 260 likewise have the centerpoint 204. The tower base element 210 additionally forms the inner circumferential surface 222 facing the centerpoint 204 and the outer circumferential surface 220 facing away from the centerpoint. The height H of the tower segment 200 is oriented orthogonally to the drawing plane. FIG. 3 reveals in particular the arrangement of the first connecting elements 302 and of the third connecting elements 306 and also of the second flange opening 234 and of the third flange openings 236. The flange openings 234, 236 are designed as a circle of holes.

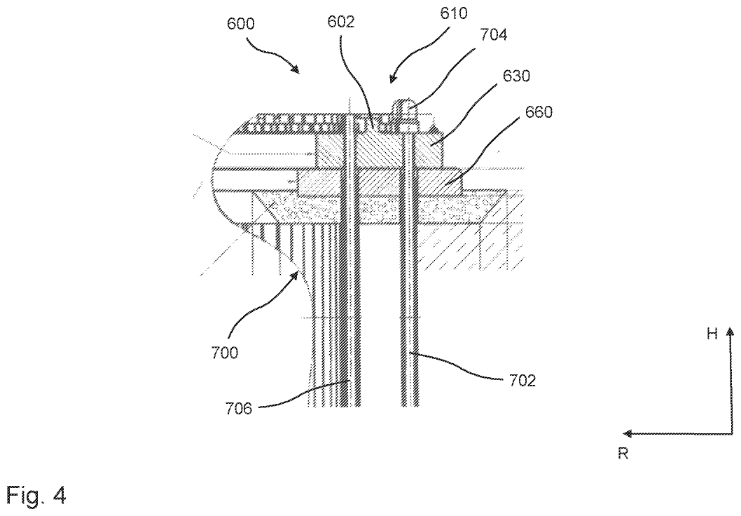

FIG. 4 shows a schematic, two-dimensional view of a tower segment known in the prior art. The tower segment 600 comprises the tower base element 610 on which a flange 630 is fixedly arranged. On an underside of the flange 630 there is arranged a load element 660. The flange 630 and the load element 660 each have through-openings through which connecting elements 702, 706 can extend, these being secured on the flange 630 by further connecting elements 704. The connecting elements 702, 706 are fastened to the foundation 700.

The tower segment 600 shown here has the disadvantage that the flange 630 determines the largest diameter of the tower segment 600 and not the tower wall 602. As a result, the tower wall 602 has to be designed to be smaller in diameter, which can lead to losses in strength and/or stiffness. Alternatively, the tower segment 600 has to be segmented in the horizontal direction.

The tower segment 103, 200 shown in FIGS. 1, 2 and 3 allows, inter alia, optimized logistics. In particular, the respective tower base element 210 can be designed to a maximum transportable diameter, in particular 4.30 m. In particular, for this dimension, it is not the diameter of the flange 230 which is limiting, since said flange is first fastened to the tower base element 210 at a set-up site of the wind power installation 100. The tower segment 103, 200 according to the disclosure can thus be transported in a simpler and more favorable manner. Moreover, this allows a better strength-related design of a wind power installation tower 102. In addition, more cost-effective mounting of a wind power installation tower 102 on a foundation 112, 300 is possible.

### REFERENCE SIGNS

100 Wind power installation

102 Tower

103 Tower segment

104 Nacelle

106 Rotor

108 Rotor blades

110 Spinner

112 Foundation

200 Tower segment

202 Tower wall

204 Centerpoint

210 Tower base element

212 Upper end

214 Lower end

216 Threaded opening

218 Thickened portion

220 Outer circumferential surface

222 Inner circumferential surface

230 Flange

232 First flange opening

234 Second flange opening

236 Third flange opening

250 Screw

252 Screw shank

254 Screw head

260 Load element

262 First load element opening

264 Second load element opening

266 Third load element opening

300 Foundation

302 First connecting element

304 Second connecting element

306 Third connecting element

308 Fourth connecting element

600 Tower segment

602 Tower wall

610 Tower base element

630 Flange

660 Load element

700 Foundation

702 First connecting element

704 Second connecting element

706 Third connecting element

H Height

R Radial direction

1. A tower segment for a tower of a wind power installation and for attaching to a support structure, comprising:
a tower base element having:
an upper end and a lower end, and
a threaded opening arranged at the lower end,
a flange, arranged at the lower end and having a first flange opening and a second flange opening,
wherein the tower base element and the flange are connected by a fastening element arranged in the threaded opening and the first flange opening, and
wherein the second flange opening is formed in such a way that a connecting element of the support structure is configured to extend through the second flange opening.

2. The tower segment as claimed in claim 1, wherein:
the threaded opening is arranged terminally at the lower end of the tower base element, and/or
the first flange opening is arranged on the flange in such a way that the first flange opening it-terminally adjoins the lower end.

3. The tower segment as claimed in claim 1, wherein at least one of the tower base element or the flange has an annular cross section.

4. The tower segment as claimed in claim 1, wherein:
the flange has a third flange opening,
the first flange opening is arranged in a radial direction between the second flange opening and the third flange opening such that the second flange opening has in the radial direction a smaller spacing from a centerpoint of the tower segment than the third flange opening in the radial direction from this centerpoint, and
the third flange opening is arranged in such a way that a connecting element of the support structure is configured to extend through the third flange opening.

5. The tower segment as claimed in claim 1, comprising:
a load element arranged on the flange and having a first load element opening and/or a second load element opening,
wherein the fastening element is partially arranged within the first load element opening, and/or the second load element opening has a common through-passage axis with the second flange opening, and
wherein the load element has a third load element opening having a common through-passage axis with the third flange opening.

6. The tower segment as claimed in claim 1, wherein:
the load element is annular or partly annular in form, and/or
the flange and the load element are formed integrally.

7. The tower segment as claimed in claim 1, wherein:
the fastening element is a screw, and/or
the fastening element has a threaded bolt and a nut, wherein the threaded bolt is screwed into the threaded opening and extends through the first flange opening and is screwed to the nut on the side of the flange that faces away from the tower base element, and/or
the fastening element has a threaded bolt, a cross bolt, with a cross bolt opening, and a nut, wherein the threaded bolt is screwed into the threaded opening and extends through the first flange opening and, on the side of the flange that faces away from the tower base element and extends through the cross bolt opening and is screwed to the nut.

8. The tower segment as claimed in claim 1, wherein a dimension of the first flange opening in the radial direction is smaller than a thickness of the tower base element in the radial direction.

9. The tower segment as claimed in claim 1, wherein:
the tower base element has at the lower end, a thickened portion having a radial extent that is greater than a radial extent of a tower wall, and/or
the upper end of the tower base element is configured for arranging a tower wall.

10. The tower segment as claimed in claim 9, comprising:
a tower wall having an annular cross section, wherein the tower wall is arranged at the upper end of the tower base element and is welded to the tower base element, and/or
the tower wall has a smaller radial extent than the tower base element, than the thickened portion of the tower base element.

11. The tower segment as claimed in claim 1, wherein a connection of the tower base element to the flange and of the flange to the load element is configured to be free of a welded connection.

12. The tower segment as claimed in claim 1, wherein the flange is a segmented flange and has at least two horizontally adjacent flange segments.

13. A tower of a wind power installation, comprising:
at least one tower segment as claimed in claim 1,
wherein the support structure is a foundation, the connecting element fixedly connected to the support structure,
wherein the first connecting element extends through the second flange opening, and through the second load opening, and
wherein the connecting element is connected to a corresponding second connecting element on the side of the flange that faces away from the support structure in such a way that a fixed connection is formed between the flange and the support structure.

14. The tower as claimed in the preceding claim 13,
wherein at least one first connecting element is a plurality of first connecting elements fixedly connected to the support structure, and
wherein one or more of the plurality of first connecting elements extends through the third flange opening, and through the third load element opening, and is connected to a corresponding second connecting element on the side of the flange that faces away from the support structure in such a way that a fixed connection is formed between the flange and the support structure.

15. A wind power installation, comprising:
a tower as claimed in claim 13, and
a nacelle coupled to the tower.

16. A method for constructing a tower of a wind power installation, the method comprising:
providing a support structure, in particular a foundation, having a first connecting element,
arranging a flange having a first flange opening and a second flange opening at a terminal lower end of a tower base element which has a threaded opening,
fastening the flange to the lower end, in particular the terminal lower end, of the tower base element by arranging a fastening element in the threaded opening and the first flange opening, and
arranging the flange on the support structure such that the first connecting element extends through the second flange opening.

17. The method as claimed in claim 16, comprising:
arranging a load element between the support structure and the flange having a first load element opening and/or a second load element opening,
arranging the fastening element at least partially within the first load element opening and/or guiding the first connecting element through the second load element opening, and
guiding a second connecting element of the support structure through a third load element opening of the load element.
